(19) United States
(12) Patent Application Publication
(10) Pub. No.: US 2021/0399604 A1
(43) Pub. Date: Dec. 23, 2021

(54) ROTOR MOUNTING UNIT HAVING A COOLING FUNCTION

(71) Applicant: ebm-papst St. Georgen GmbH & Co. KG, St. Georgen (DE)

(72) Inventors: Volker EHLERS, St. Georgen (DE); Frederick WURSTHORN, Villingen-Schwenningen (DE)

(21) Appl. No.: 17/287,807

(22) PCT Filed: Oct. 23, 2019
(86) PCT No.: PCT/EP2019/078793

§ 371 Date: Apr. 22, 2021

(30) Foreign Application Priority Data
Nov. 23, 2018 (DE) 10 2018 129 611.8

(51) Int. Cl. H02K 5/173; H02K 5/20; H02K 7/08; H02K 9/06

(52) U.S. Cl. CPC H02K 5/1735; H02K 5/207; H02K 2205/09; H02K 9/06; H02K 7/085

(57) ABSTRACT

The disclosure relates to a rotor assembly (10) having an integrated heat conducting channel for a high-speed radial ventilator, comprising a bearing tube (20) which is axially open on the inside and in which a shaft (40) that supports a ventilator wheel (30) is mounted on bearings (24, 25). Shaft comprises a rotor (50) of a canned motor, wherein the bearing tube (20) has an outwardly protruding radial projection (21), a heat dissipation portion (23) of which at least partially extends beyond the outer circumference (31) of the ventilator wheel (30), and which provides an integrated heat conducting channel that extends from the bearing (24) to the heat dissipation portion (23).

### FIELD

The disclosure relates to a rotor assembly having a ventilator wheel and to a radial fan with such a rotor assembly having an integrated cooling function.

### BACKGROUND

The problem with radial ventilators is that heat is generated inside the bearings of the rotor shaft due to mechanical friction and this leads to overheating. This problem particularly concerns radial fans for high-speed applications which are to be installed in a unitary separating can axially closed on one side, since there the heat is additionally prevented from being thermally transferred to the outside by the separating can.

### SUMMARY

As used in the present disclosure, high-speed applications are speeds of the ventilator wheel for which the circumferential speed at the radial compressor outlet is at least 60 m/s. This further exacerbates the thermal problem since additional heat is inevitably generated as the speed increases.

In some applications, high-speed fan housings are made of a metal. This ensures cooling and the heat can readily escape through the thermally conductive housing wall. Alternatively, for larger or stationary high-speed fans, a more complex oil or water cooling system can be employed. If a medium can be used for cooling, this medium flows around the area to be cooled.

In the event that the housing is made entirely of metal, the disadvantage is that only limited shaping and connection techniques can be applied. Whereas forming the primary housing of the ventilator from plastics allows greater freedom of form and enables alternative joining methods, heat transfer is then unsatisfactory.

When cooling the bearings using auxiliary media such as oil or water, this requires considerable design effort and additional sets.

Therefore, aspects of example embodiments overcome the aforementioned disadvantages and provide a rotor assembly of a radial ventilator, in particular a high-speed radial ventilator, which offers optimized cooling capability for cooling bearings.

Advantages are achieved by the combination of features according to claim 1.

To this end, according to the example embodiment, a rotor assembly having an integrated heat conducting channel for a high-speed radial ventilator is proposed, comprising a bearing tube which is axially open on the inside and in which a shaft that supports a ventilator wheel is mounted on bearings, which shaft comprises a rotor of a canned motor, wherein the bearing tube has an outwardly protruding radial projection, a heat dissipation portion of which at least partially extends beyond the outer circumference of the ventilator wheel, and which provides an integrated heat conducting channel that extends from the bearing to the heat dissipation portion.

The larger diameter range of the projection extends beyond the diameter of the fan wheel (radial construction or diagonal construction). This ensures that the air flow from the fan wheel passes over the edge region of the enlarged diameter of the bearing tube.

This creates a heat sink by coupling to the media flow of the fan wheel. The heat quantity generated inside the rotor system is mainly dissipated by heat conduction. For this effect to become manifest, the material of the protruding heat dissipation portion must have a thermal conductivity of at least 1 W/m*K. However, it is not relevant whether the heat dissipation portion is made of the same part or material as the bearing tube itself. The construction can be formed in different ways, i.e., integrally, unitarily or in multiple sections or parts.

In the case of radial fans, a leakage flow underneath the fan wheel, which additionally contributes to the dissipation of thermal energy, is also convenient in practice.

If a relatively narrower collar is used as the heat dissipation portion, the leakage flow underneath the impeller can be used for cooling.

As such, in an advantageous embodiment of the disclosure, it is provided that the projection is formed as a substantially round plate-shaped projection, the diameter D_{A} of which is larger than the diameter D_{V} of the ventilator wheel.

It is further advantageous if the projection has an outer circumferential collar which extends in the axial direction and the radial edge region of the fan wheel at least

As such, an embodiment is particularly advantageous in which the shaft is mounted on a first bearing arranged within the bearing tube and a second bearing spaced axially therefrom and arranged within the bearing tube in an area between the ventilator wheel and the rotor, and an end portion of the shaft protrudes from the ventilator wheel to dissipate the heat into the fan housing. Thereby, an additional heat dissipation channel is created via the shaft and the end portion of the shaft forms a heat sink. As a result, the media flow taken in axially by the ventilator, e.g., the intake air, flows along the end portion of the shaft and is then passed into the radial flow channel.

Another aspect of the example embodiments relates to a radial ventilator having a ventilator housing in which a rotor assembly as described above is installed, wherein the ventilator housing has a recess and the heat dissipation portion of the bearing tube, as intended, projects into or adjoins the recess with a heat dissipation surface such that, when the ventilator is in operation, the media flow conveyed by the ventilator wheel flows along the heat dissipation surface, thereby forming a heat sink at the heat dissipation surface opposite the bearings. In this way, heat is transferred from the two bearings to the heat dissipation surface at the collar of the projection via the bearing tube, whereby heat can be dissipated in a targeted manner.

In a further advantageous embodiment, it is provided that the recess is at least partially located in a radially outer flow channel of the ventilator housing.

Preferably, an axial portion of the bearing tube receives the bearings directly and a cylindrical housing portion of the ventilator housing encloses this axial portion of the bearing tube.

It is also advantageously provided that a circumferentially closed separating can connects (directly) to the cylindrical housing portion and, more preferably, the separating can is formed unitarily with the ventilator housing.

Further, an embodiment is particularly advantageous in which the bearing tube rests flat on a housing base plate of the ventilator housing with its radial projection. In addition to being easy to install, a higher heat capacity of the bearing tube can be generated due to a flat connection and heat dissipation.

### BRIEF DESCRIPTION OF THE DRAWINGS

Other advantageous developments of the example embodiments are characterized in the dependent claims or are shown in greater details below in conjunction with the description of the example embodiments with reference to the figures. In the drawings:

FIG. 1 shows a sectional side view of an example embodiment of a rotor assembly,

FIG. 2 shows a sectional side view of an example embodiment of a radial ventilator,

FIG. 3 shows a perspective sectional view through the radial ventilator according to FIG. 2,

FIG. 4 shows a top view of the example embodiment according to FIG. 1, and

FIGS. 5, 6, 7, 8 and 9 show further example embodiments of the disclosure.

### DETAILED DESCRIPTION OF EXAMPLE EMBODIMENTS

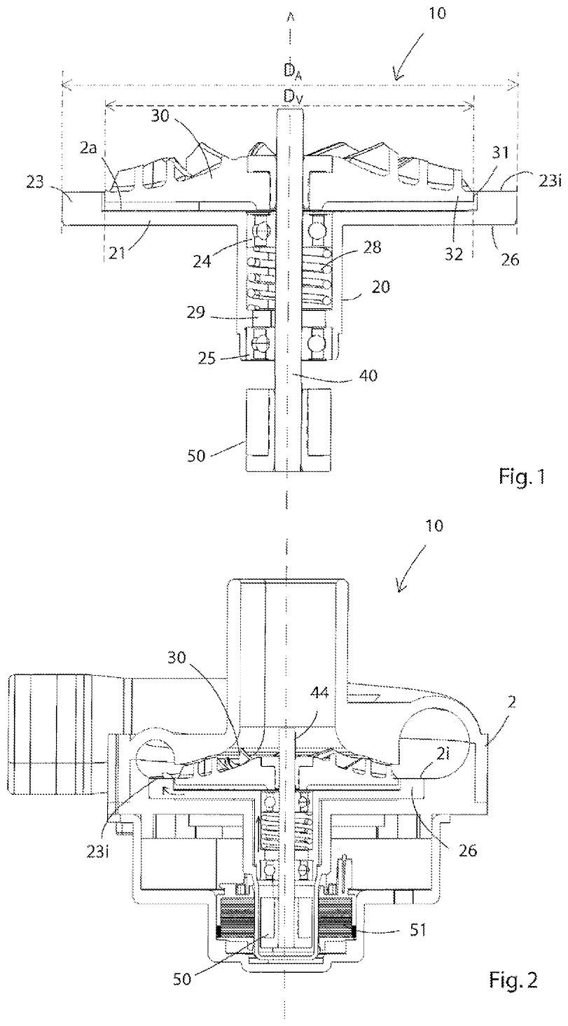

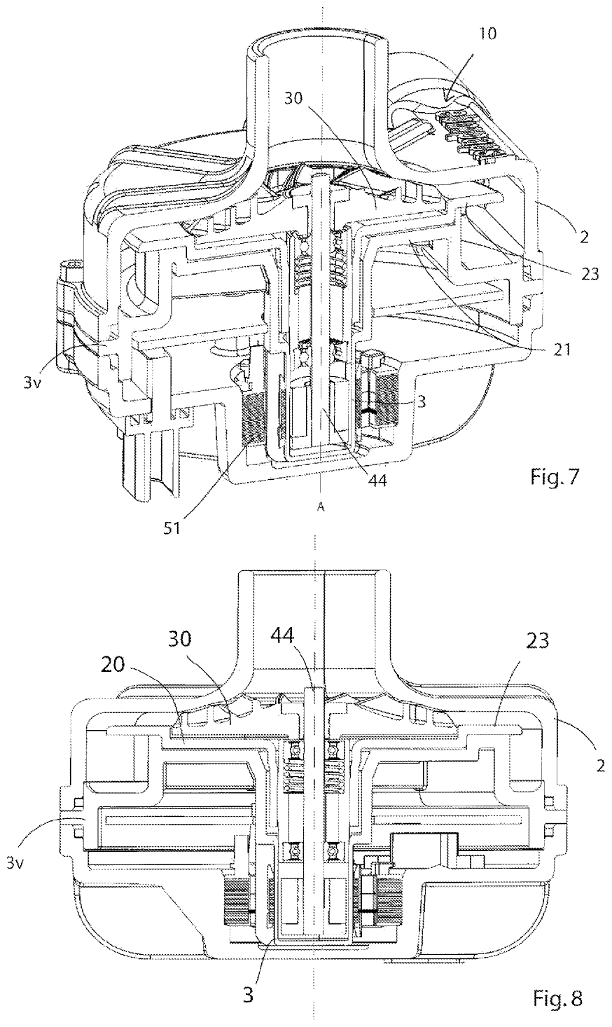

The disclosure is described in greater detail below with reference to FIGS. 1 to 9, in which similar reference numerals denote similar structural and/or functional features.

FIG. 1 shows an exemplary embodiment of a rotor assembly 10.

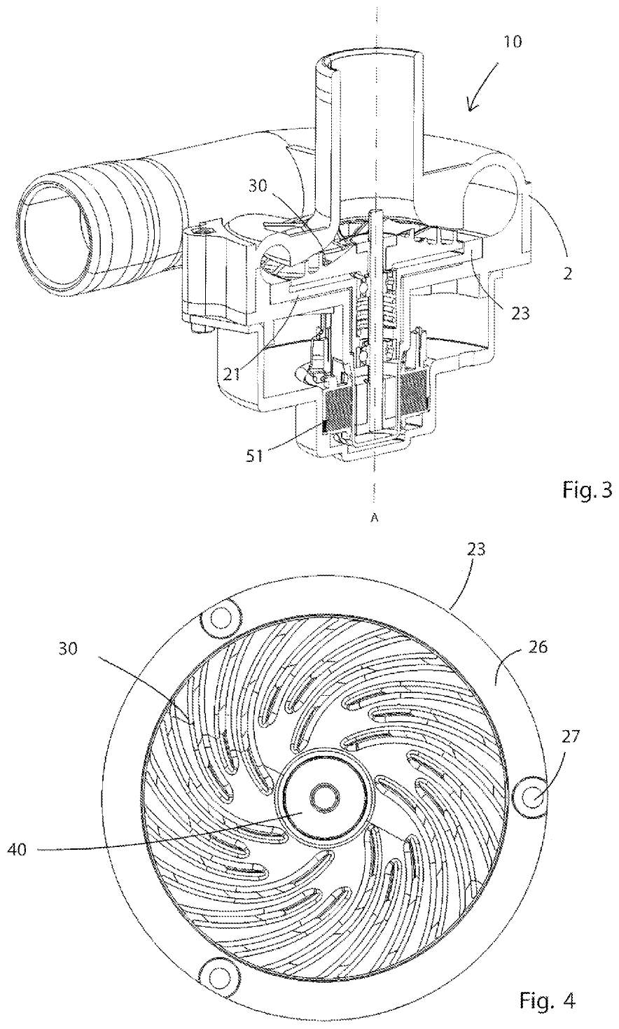

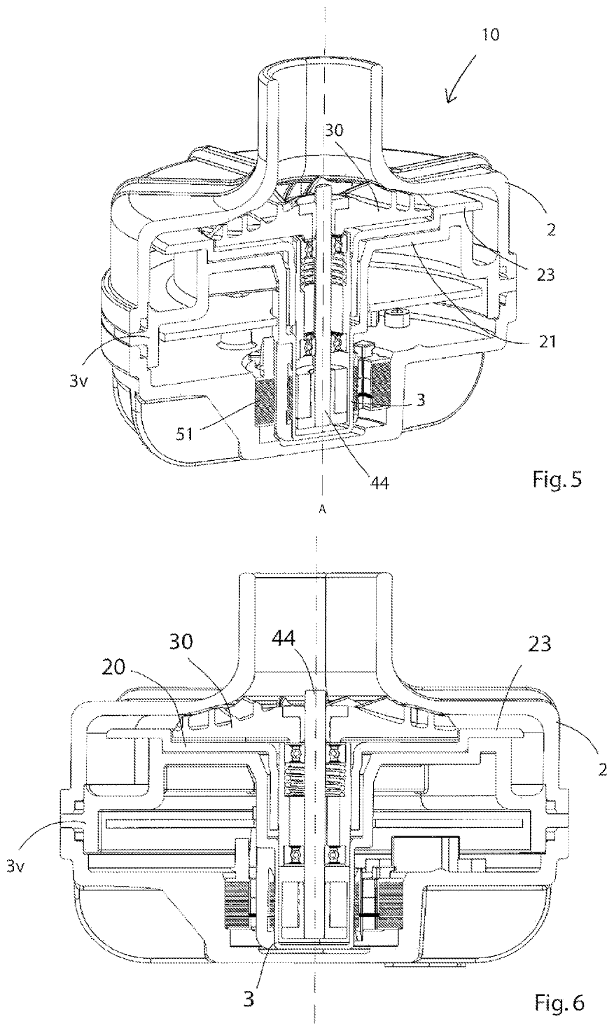

Rotor assembly 10 is designed for a high-speed radial ventilator. Rotor assembly 10 comprises a bearing tube 20 which is axially open on the inside. A shaft 40 is mounted inside bearing tube 20, with a rotor 50 of a canned motor being mounted on shaft 40. The external stator 51 of the motor is shown in FIG. 2 and FIG. 3. Bearing tube 20 has an outwardly projecting radial projection 21.

This projection 21 extends with a heat dissipation portion 23 beyond the outer circumference 31 of ventilator wheel 30 and provides an integrated heat conduction channel 20 which extends from bearings 24 to heat dissipation portion 23. For this purpose, the material must have the desired thermal conductivity according to the requirements, which can transfer the generated heat flow.

In both the sectional view according to FIG. 2 and the perspective sectional view of FIG. 2, it can be clearly seen that projection 21 extends beyond outer circumference 31 of ventilator wheel 30. Projection 21 is substantially formed as a round plate-shaped projection, the diameter D_{A} of which is larger than the diameter D_{V} of ventilator wheel 30.

Projection 21 also has an outer circumferential upwardly projecting collar 23 which extends in the axial direction A and radially outwardly surrounds radial edge region 32 of the ventilator wheel 30. In other words, ventilator wheel 30 is placed on shaft 40 such that ventilator wheel 30 is arranged within the depression in projection 21.

As can be seen in FIG. 3, edge region 26 of projection 21, which is located radially outside ventilator wheel 30, has three fastening openings 27. By means of fastening openings 27, the entire rotor assembly 10 can be fastened to ventilator housing 2 of the radial ventilator, as shown in FIG. 2. As such, the three fastening openings 27 are arranged in circumferential collar 23.

Shaft 40 is mounted between two bearings 24, 25, a spring 28 being biased against the first bearing 24 and supported on an inner flange web 29. The second one (lower bearing 25 in FIG. 3) sits at the lower end of bearing tube 20 and is supported against flange web 29. Shaft 40 with rotor 50 projects through lower bearing 25.

FIG. 2 further shows ventilator housing 2. Bearing tube 20 is supported on housing base plate 2a by its radial projection 21 and is connected to ventilator housing 2 by means of a screw connection. Further, bearing tube 20 projects with shaft 40 and rotor 50 mounted on shaft 40 into a circumferentially closed (open-top) separating can 3 which is part of ventilator housing 2 of a radial ventilator (only partially shown) and is formed unitarily therewith.

Shaft 40 projects from ventilator wheel 30 with an end portion 44 into ventilator housing 2 to dissipate the heat. The ventilator housing has a recess 2i and heat dissipation portion 23 of bearing tube 20 thus projects into recess 2i with its heat dissipation surface 23i. Heat dissipation surface 23i forms a heat sink opposite bearings 24, 25.

As can be clearly seen in FIG. 2, recess 2i is located in a radially outer flow channel 2s of ventilator housing 2.

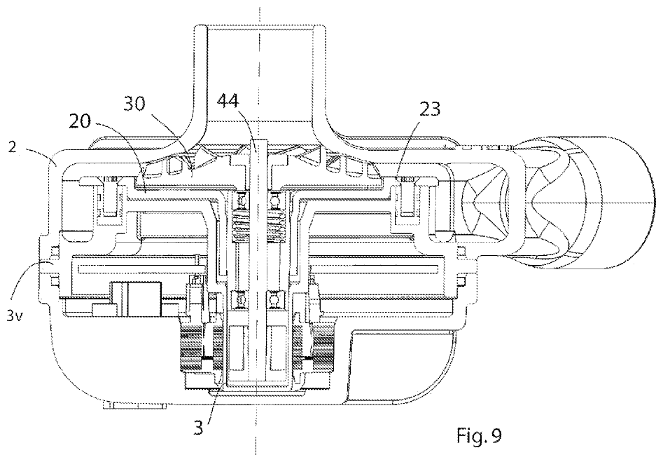

FIGS. 5 to 9 show further embodiments of the disclosure, wherein the design of housing 2, separating can 3, bearing tube 20 and the design of heat dissipation portion 23, in particular, take an alternative form. The projection of separating can 3v can also be seen, which extends between an upper housing part and lower housing part of housing 2. FIG. 9 also shows that a fastening opening is provided in the area of heat dissipation portion 23 in order to fasten the projection of bearing tube 20 to the projection of separating can 3.

The manner in which the example embodiments are carried out is not limited to the exemplary embodiments given above. Instead, a number of variations are conceivable which make use of the solution shown even when embodied in fundamentally different forms. Thus, the recess 2i shown could also be formed as a plurality of adjacent openings or holes in the ventilator housing in the same area.

1. A rotor assembly (10) having an integrated heat conducting channel for a high-speed radial ventilator, comprising a bearing tube (20) which is axially open on the inside and in which a shaft (40) that supports a ventilator wheel (30) is mounted on bearings (24, 25), which shaft comprises a rotor (50) of a canned motor, wherein the bearing tube (20) has an outwardly protruding radial projection (21), a heat dissipation portion (23) of which at least partially extends beyond the outer circumference (31) of the ventilator wheel (30), and which provides an integrated heat conducting channel that extends from the bearing (24) to the heat dissipation portion (23).

2. The rotor assembly (10) according to claim 1, characterized in that the projection (21) is formed as a substantially round plate-shaped projection, the diameter D_{A} of which is larger than the diameter D_{V} of the ventilator wheel.

3. The rotor assembly (10) according to claim 1, characterized in that the projection (21) has an outer circumferential collar (23) which extends in the axial direction and radially outwardly encloses a radial edge region (32) of the ventilator wheel (30) at least partially or across the entire circumference.

4. The rotor assembly (10) according to claim 1, characterized in that the shaft (40) is mounted on a first bearing (24) arranged within the bearing tube (20) and a second bearing (25) spaced axially therefrom and arranged within the bearing tube (20) in a region between the ventilator wheel (30) and the rotor (50), and an end portion (44) of the shaft (40) protrudes from the ventilator wheel (30) into the ventilator housing (2) to dissipate the heat.

5. A radial ventilator, having a ventilator housing (2) in which a rotor assembly (10) according to any one of the preceding claims is installed, wherein the ventilator housing (2) has a recess (2i) and the heat dissipation portion (23) of the bearing tube (20) protrudes into the recess (2i) with a heat dissipation surface (23i) such that, when the ventilator is in operation, the media flow conveyed by the ventilator wheel flows along the heat dissipation surface (23i) and thereby forms a heat sink at the heat dissipation surface (23i) opposite the bearings (24, 25).

6. The radial ventilator according to claim 5, characterized in that the recess (2i) is at least partially located in a radially outer flow channel (2s) of the ventilator housing (2).

7. The radial ventilator according to claim 5, characterized in that an axial portion of the bearing tube (20) receives the bearings (24, 25) and, around said axial portion, a cylindrical housing portion (2z) of the ventilator housing (2) encloses the axial portion of the bearing tube (20).

8. The radial ventilator according to claim 7, characterized in that a circumferentially closed separating can (3) connects to the cylindrical housing portion (2z).

9. The radial ventilator according to claim 8, characterized in that the separating can (3) is formed unitarily with the ventilator housing (2).

10. The radial ventilator according to claim 5, characterized in that the bearing tube (20) rests flat on a housing base plate (2a) of the ventilator housing (2) with its radial projection (21).
